(19) United States
(12) Patent Application Publication
(10) Pub. No.: US 2018/0283485 A1
(43) Pub. Date: Oct. 4, 2018

(54) FLUID DAMPER

(71) Applicant: SUSPA GmbH, Altdorf (DE)

(72) Inventors: Marc-Pascal BOßLE, Altdorf (DE); Ludwig FELLNER, Altdorf (DE); Stefan HILDNER, Eckental (DE); Helmut KASTNER, Neukirchen (DE); Thilo SLABY, Altdorf (DE); Herbert WOLF, Altdorf (DE)

(21) Appl. No.: 15/928,333

(22) Filed: Mar. 22, 2018

(30) Foreign Application Priority Data
Mar. 31, 2017 (DE) 10 2017 205 568.5

(51) Int. Cl. F16F 9/348; F16F 9/36

(52) U.S. Cl. CPC F16F 9/3481; F16F 9/3484; B64D 11/003; F16F 9/369; F16F 9/368

(57) ABSTRACT

A fluid damper comprises a housing having a working chamber, a damping fluid disposed in the working chamber, a piston unit arranged in the working chamber, the piston unit comprising a piston rod, a piston secured to the piston rod in such a way as to divide the working chamber in a first working chamber part and a second working chamber part, at least one flow duct interconnecting the first working chamber part and the second working chamber part, at least one bypass duct interconnecting the first working chamber part and the second working chamber part, an overload valve that blocks a fluid flow through the bypass duct in a blocking position and is arranged in a release position as soon as a minimum fluid pressure is reached, wherein in said release position, a fluid flow through the bypass duct is possible.

### CROSS-REFERENCE TO RELATED APPLICATIONS

This application claims priority of German Patent Application Serial No. DE 10 2017 205 568.5, filed on Mar. 31, 2017, pursuant to 35 U.S.C. 119(a)-(d), the content of which is incorporated herein by reference in its entirety as if fully set forth herein.

### FIELD OF THE INVENTION

The invention relates to a fluid damper, in particular a hydraulic damper.

### BACKGROUND OF THE INVENTION

A fluid damper is configured such that a piston secured to a piston rod is moved in a housing against a damping fluid. The speed of the piston is reduced by the damping fluid in such a way that a damping force is generated. The damper curve, in other words the damping force generated by the damper as a function of an actuation speed of the damper, is progressive. The more rapidly the damper is actuated, the higher the damping force generated by the damper. An excess damping force may cause damages to and/or failure of components of the damper and/or may damage the connection of the damper to the components to be damped, such as a housing of an overhead locker.

### SUMMARY OF THE INVENTION

The invention is based on the object of improving a fluid damper in such a way that damages to the damper and/or to its connection to the components to be damped, caused in particular by inappropriate use, are excluded.

This object is achieved by a fluid damper comprising a housing having a working chamber, a damping fluid disposed in the working chamber, a piston unit arranged in the working chamber, the piston unit comprising a piston rod, a piston secured to the piston rod, the piston dividing the working chamber in a first working chamber part and a second working chamber part, at least one flow duct interconnecting the first working chamber part and the second working chamber part, at least one bypass duct interconnecting the first working chamber part and the second working chamber part, an overload valve that blocks a fluid flow through the bypass duct in a blocking position and is arranged in a release position as soon as a minimum fluid pressure is reached, wherein in said release position, a fluid flow through the bypass duct is possible. The gist of the invention is that a fluid damper is provided with an overload valve configured to open a bypass duct as soon as a minimum fluid pressure for a fluid flow is reached. It has been found that the fluid damper comprising the bypass duct has a damper curve with a significant plateau region. In this plateau region, the fluid damper has a substantially constant damping force, which is in particular independent of the actuating speed. An inadvertent false actuation of the damper does not cause damages to the fluid damper or its connection to the components to be damped. A maximum damping force acting on the damper is limited reliably. The fluid damper provides the damping function by means of at least one flow duct, which allows a damping fluid in a working chamber to flow from a first working chamber part into a second partial working chamber. The working chamber is divided into the first working chamber part and the second working chamber part by a piston secured to a piston rod. The piston rod is guided for displacement along the longitudinal axis of a housing of the fluid damper. The bypass duct provides an additional fluid connection towards the flow duct. The bypass duct is a bypass fluid connection. The overload valve is arranged in particular along the bypass duct. In the blocking position, a fluid flow through the bypass duct is blocked. The blocking position is provided if the pressure in the fluid damper falls below the minimum fluid pressure after actuating the piston rod. In the blocking position of the overload valve, the fluid damper ensures the damping function of a conventional fluid damper.

A fluid damper in which the minimum fluid pressure is adjustable allows a maximum permissible fluid pressure in the damper to be adapted individually. When the minimum fluid pressure is reached, the overload valve is moved from the blocking position into the release position. This process is also referred to a switching process. The minimum fluid pressure is therefore also referred to as switching process. The switching process is carried out in particular by means of passive components. In the release position, a further increase of the fluid pressure is substantially impossible. The bypass duct provides a sufficient flow area for the damping fluid. The overload valve is in particular configured such that the switching process is force-controlled. The damping components influencing the switching process, such as components shutting off the bypass duct and/or an effective flow area of the bypass duct, immediately define the minimum fluid pressure.

At least one sealing member configured to seal the bypass duct in the blocking position ensures a reliable sealing of the bypass duct in the blocking position. This prevents a fluid flow through the bypass duct in the blocking position thereof.

A seal seat against which the sealing member abuts in a sealing manner in the blocking position improves the reliability of the sealing of the bypass duct in the blocking position.

A valve serves as a spring member and in particular as a sealing member. The resilient force generated by the spring member in particular acts counter to the fluid pressure in the bypass duct generated by the minimum fluid pressure. The valve disk defines the resilient force acting counter to fluid pressure. The effective spring force is in particular dependent on the number of the valve disks used, on the thickness of the valves disks, on the geometric boundary conditions allowing an elastic deformation of the valve disk caused by the fluid pressure, a lever arm of the fluid pressure acting on the valve disk. In a particularly advantageous embodiment, the valve disk may serve as the sealing member at the same time.

In addition or as an alternative thereto, a fluid damper may be provided with a sealing ball serving as sealing member. The sealing member may also have a different geometry, for example a conical shape, a cylindrical shape, a cuboid shape or a cubic shape.

A fluid damper configured such that the bypass duct has a first flow cross-sectional area that is greater than a second flow cross-sectional area of the flow duct ensures a reliable relief of the maximum forces in the damper. As the bypass duct has a first flow cross-sectional area that is greater than a second flow cross-sectional area of the flow duct, it is guaranteed that the fluid to be displaced is able to flow from one working chamber part into the other working chamber part even in the event of a high load acting on the fluid damper. The first flow cross-sectional area of the bypass duct is in particular at least twice, in particular at least four times, in particular at least eight times, and in particular at least ten times the size of the second flow cross-sectional area of the flow duct. It is conceivable as well to provide more than one bypass ducts to be opened by the overload valve. The first flow cross-sectional areas of the bypass ducts must therefore be added accordingly. The bypass ducts may be configured identically or differently. A different configuration of the bypass ducts is provided in such a way, for example, that the bypass ducts have different flow cross-sectional areas. A different configuration is also provided by the radial distance of the bypass duct from the longitudinal axis. Different bypass ducts as described above may provide different switching points in one and the same overload valve. It is conceivable to provide an overload valve having more than one switching point.

It is conceivable as well to provide a plurality of flow ducts to set the damping effect of the fluid damper in the blocking position accordingly. The damping effect of the fluid damper is dependent on the flow cross-sectional area.

An overload valve, which has a compact design, in particular in the axial direction of the fluid damper, and/or lightweight design, allows an advantageous retrofitting of already existing fluid dampers. In particular, the overload valve may be mounted to a piston of the fluid damper in a compact and/or lightweight manner.

A valve body, which is in particular secured to the piston rod, allows an advantageous retrofitting of the overload valve. The valve body may be secured to the piston rod of the fluid damper in a simple manner

Integrating the bypass duct into the valve body allows an advantageous setting of the minimum fluid pressure. The overload valve is compact and mechanically sturdy.

A support ring of the overload valve, the support ring in particular being secured to the piston rod, with the valve disk in particular being arranged between the support ring and the valve body, provides an advantageous stabilization of the valve body.

A flow sealing member of the piston unit, the flow sealing member in particular being configured as a piston ring, permits sealing of the flow duct, in particular in the release position thereof. The flow sealing member is in particular configured as a ring member abutting against an inner side of the housing of the fluid damper in particular in a radially sealing manner The flow sealing member is displaceable in particular along the longitudinal axis of the housing of the fluid damper.

Other advantageous embodiments, additional features and details of the invention will be apparent from the ensuing description of two exemplary embodiments, taken in conjunction with the drawing.

### BRIEF DESCRIPTION OF THE DRAWING

FIG. 1 shows a longitudinal sectional view of a first exemplary embodiment of a fluid damper according to the invention;

FIG. 2 shows an enlarged view of detail II in FIG. 1, with an overload valve being in a blocking position;

FIG. 3 shows a view, corresponding to FIG. 2, of the overload valve in a release position;

FIG. 4 shows a perspective view of a valve body of the overload valve according to FIG. 2;

FIG. 5 shows a view of the valve body from below;

FIG. 6 shows a view of the valve body from above;

FIG. 7 shows an enlarged side view of the valve body;

FIG. 8 shows a perspective view of a valve disk of the overload valve according to FIG. 2;

FIG. 9 shows a view, corresponding to FIG. 1, of a fluid damper according to a second exemplary embodiment;

FIG. 10 shows an enlarged view of detail X in FIG. 9, with an overload valve being in the blocking position;

FIG. 11 shows a view, corresponding to FIG. 10, of the overload valve in the release position;

FIG. 12 shows a perspective view of the valve body of the overload valve in FIG. 10;

FIG. 13 shows a plan view of the valve body according to FIG. 12;

FIG. 14 shows a sectional view according to section line XIV-XIV in FIG. 13;

FIG. 15 shows a sectional view according to section line XV-XV in FIG. 13;

FIG. 16 shows a schematic view of damper curves of prior art fluid dampers and of a fluid damper according to the invention.

### DESCRIPTION OF THE PREFERRED EMBODIMENT

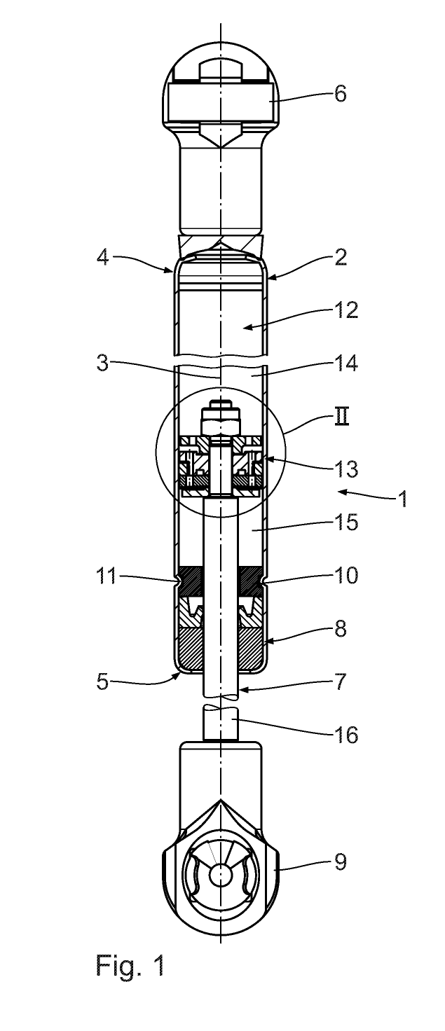

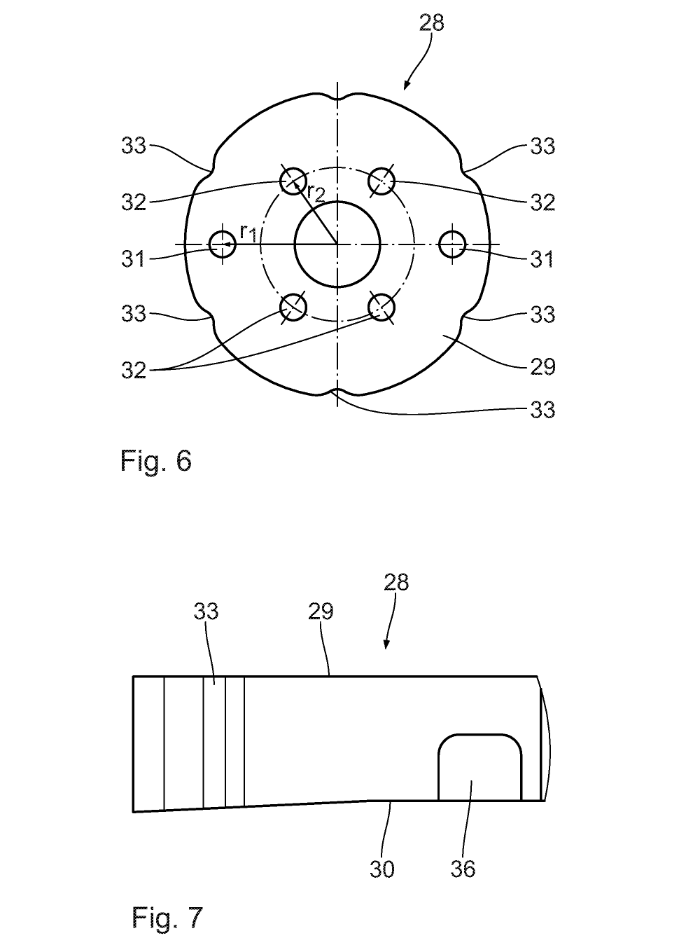

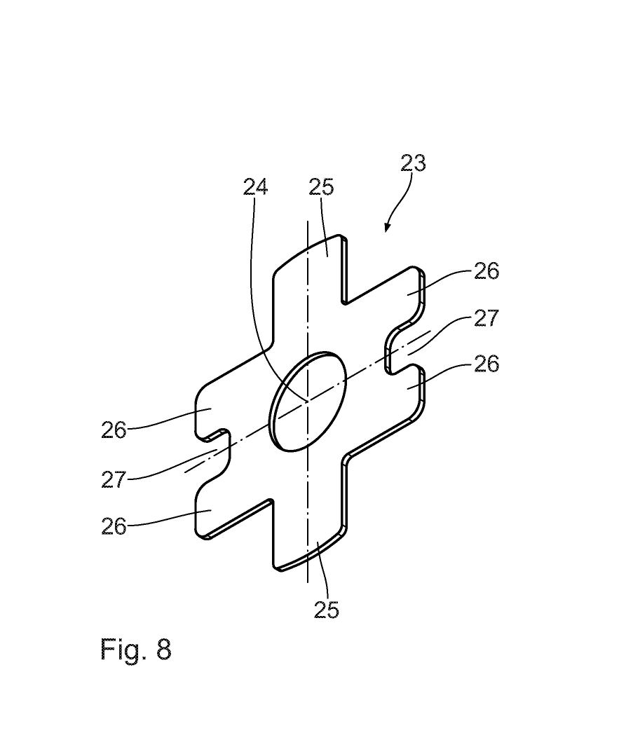

A fluid damper 1 shown in FIGS. 1 to 8 is a hydraulic damper such as those used in an overhead locker of a plane to damp the pivoting movement of the overhead locker in relation to a housing and to control the pivoting speed.

The fluid damper 1 has a substantially cylindrical housing 2 with a longitudinal axis 3. The housing 2 has a first closed end 4 shown at the top of FIG. 1 and a second open end 5 arranged opposite the first end 4. The first end 4 of the housing 2 is provided with a first fastening member 6 configured as a ball head adapter. The first fastening member 6 may also be configured differently. The first fastening member 6 is used to fasten the housing to a first component such as an articulation point of the stationary overhead locker.

At the second end 5, a piston rod 7 is guided out of the housing 2 in a sealed manner To this end, a guiding/sealing unit 8 is arranged in the region of the second end 5 in the housing 2, said guiding/sealing unit 8 ensuring a guided displacement of the piston rod 7 along the longitudinal axis 3 of the housing 2. The guiding/sealing unit 8 is held axially in the housing 2 in relation to the longitudinal axis 3 by means of a retaining disk 10 secured in the housing 2 by means of an encircling bead 11. The piston rod 7 is displaceable along the longitudinal axis 3. The piston rod 7 is arranged in particular concentrically in relation to the longitudinal axis 3 in the housing 2. The longitudinal axis 3 is also the longitudinal axis of the piston rod. At a free end arranged outside the housing 2, a second fastening member 9 configured as a ball head adapter is provided on the piston rod 7. The second fastening member 9 may also be configured in any other way and serves to mount the fluid damper 1 to a second component, which is movable in relation to the first component, in particular a lid pivotably articulated to the overhead locker allowing the overhead locker to be closed.

For the sake of illustration, the housing 2 and the piston rod 7 are shown by interrupted lines in FIG. 1. The actual lengths of the piston rod 7 and of the housing 2 along the longitudinal axis 3 are adapted to the displacement path required for a pivot connection.

A working chamber 12 is defined by the housing 2 and the retaining disk 10. In the working chamber 12, a damping fluid is arranged, which is hydraulic oil in the exemplary embodiment shown. It is conceivable as well to use another liquid as damping fluid. It is conceivable as well to provide a gaseous damping fluid. The damping fluid may also be configured as a mixture of liquid and gas.

A second end of the piston rod 7 is arranged inside the housing 2, in other words inside the working chamber 12. At an end of the piston rod 7 arranged in the working chamber 12, a piston unit 13 is fastened that divides the working chamber 12 in a first working chamber part 14 and a second working chamber part 15. The first working chamber part 14 is defined by the housing 2 and the piston unit 13. The second working chamber part 15 is defined by the housing 2, the piston unit 13 and the retaining disk 10.

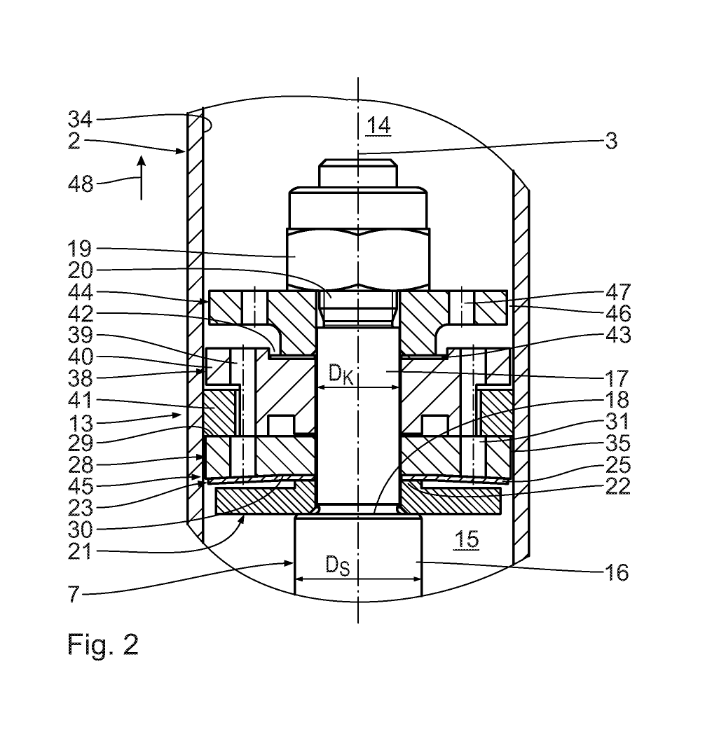

The structure and functioning of the piston unit 13 will hereinafter be explained in more detail by means of FIGS. 2 to 8.

The piston rod 7 has a cylindrical shank portion 16 and a piston portion 17. The diameter D_{S} of the shank portion 16 is greater than the diameter D_{K} of the piston portion 17. At the transition from the shank portion 16 to the piston portion 17, a shoulder 18 is formed to ensure that the piston unit 13 is axially supported on the piston rod 7 in the axial direction of the longitudinal axis 3. The piston unit 13 is axially secured by a fastening member 19 configured as a lock nut screwed to a threaded portion 20 at the free end of the piston rod 7.

The piston unit 13 has a modular, in particular multi-part design. The piston unit 13 comprises a protective washer 21, which is axially supported on the front end of the shoulder 18 of the piston rod 7. The protective washer is also referred to as support ring. At its front face remote from the shoulder 18, the protective washer 21 has an annular collar 22. The annular collar 22 is formed in one piece with the protective washer 21. The annular collar 22 has an external diameter, which is smaller than the external diameter of the protective washer 21. In particular, the external diameter of the annular collar 22 is at most 60%, in particular at most 50%, and in particular at most 45% of the external diameter of the protective washer 21.

A valve disk 23 is arranged on the front face of the annular collar 22. The valve disk 23 has double axial symmetry relative to its center 24, which is arranged concentrically in relation to the longitudinal axis 3, and displays substantially the shape of a cross. The valve disk 23 is a planar part, which is in particular made in the form of a sheet metal cutting. In a first preferred direction, the valve disk 23 has two main protrusions 25. The main protrusions 25 are arranged diametrically opposite one another in relation to the center 24. The main protrusions 25 are each configured substantially in the shape of a rectangle, with the free corner areas thereof being rounded. In a second main direction, which is perpendicular to the first main direction and represents a secondary direction, two respective secondary protrusions 26 are provided, which are spaced from each other by a respective notch 27 disposed therebetween. The two secondary protrusions 26 arranged adjacent to one another run parallel to the secondary direction. The secondary protrusions 26 arranged in pairs in such a way as to be opposite each other are arranged parallel to one another.

The valve disk 23 is so thin that it is flexible when being deformed in relation to the disk plane. The valve disk 23 is deformable in an elastically reversible manner in a direction perpendicular to the disk plane.

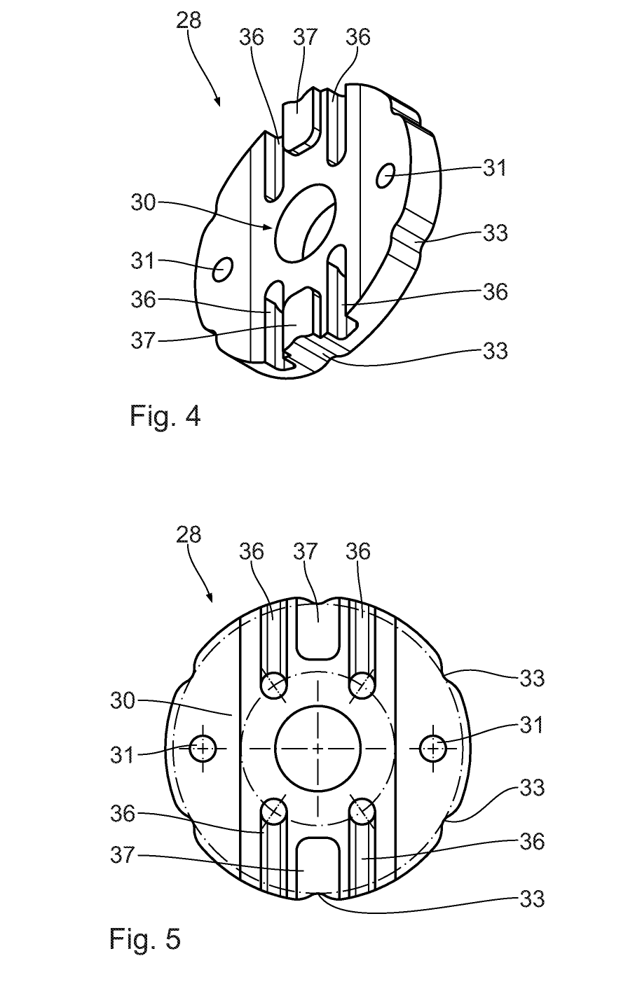

Seen along the longitudinal axis 3, a valve body 28 is arranged adjacent to the valve disk 23, with details thereof being shown in FIGS. 4 to 7.

The valve body 28 is substantially disk-shaped with a first front face 29, which has an in particular planar, in other words flat design, and with a second front face 30, which has a non-planar, in particular concave design. The valve body 28 abuts, with its second front face 30, against the valve disk 23.

The valve body 28 has two first through borings 31 arranged diametrically opposite one another on the valve body 28 in relation to the longitudinal axis 3. The first through borings 31 are arranged along a first circular line having a first radius r₁. It is conceivable as well to provide more than two or less than two first through borings 31.

The valve body 28 has four second through borings 32 arranged along a second circular line having a second radius r₂. The second radius r₂ is smaller than the first radius r₁. The second through borings 32 are each arranged in pairs in a diametrically opposite configuration relative to the longitudinal axis 3. Along the second circular line of the second through borings 32, these are arranged at unequal distances from one another. It is conceivable as well to provide less than four or more than four second through borings 32, which may in particular also be arranged at equal distances from one another along the second circular line.

The valve body 28 has a plurality of recesses 33 along its outer circumference, with six recesses 33 being provided in the exemplary embodiment shown. Together with the inner wall 34 of the housing 2, the recesses 33 form axial ducts 35 along which the damping fluid is able to flow when the piston unit 13 is being displaced along the longitudinal axis 3. Since the external diameter of the valve body 28 is smaller than the internal diameter of the housing 2, the axial ducts 35 are interconnected by an annular duct extending along the entire circumference. An annular axial duct is formed, which, because of the axial ducts 35, has a comparatively larger flow area in the region of the recesses 33.

The second front face 30 is provided with transverse ducts 36, which are guided in an open manner from the second through borings in the valve body 28 towards the outer circumference. The transverse ducts 36 permit a fluid flow through the second through borings 32 firstly along the longitudinal axis 3 in an open manner, and then in a direction transverse to the longitudinal axis 3, i.e. in a plane perpendicular thereto.

Between two adjacent transverse ducts 36, a respective centering protrusion 37 is provided in each case, which corresponds to the notch 27 of the valve disk 23. In the assembled configuration of the piston unit 13, the valve disk 23 is placed on the valve body 28 in such a way that the centering protrusions 37 each engage a respective one of the notches 27. The main protrusions 25 cover the first through borings 31. The secondary protrusions 26 each cover one of the transverse ducts 36 in the axial direction of the longitudinal axis 3. The transverse ducts 36 are each open at the outer circumference of the valve body 28, in other words in the radial direction of the longitudinal axis 3.

The piston unit 31 is provided with a piston 38 arranged adjacent to the valve body 28 along the longitudinal axis 3. The piston has a plurality of axial borings 39, which are in particular flush with the first through borings 31.

On a front face remote from the valve body 28, the piston 38 has an encircling annular web 40. The annular web 40 forms an axial stop for a piston ring 41. The piston ring 41 forms a flow sealing member. The piston ring abuts against the inner wall 34 of the housing 2 in a radially sealing manner. The piston ring 41 has a rectangular cross-sectional area. The piston ring 41 is axially displaceable along the longitudinal axis 3 between the annular web 40 and the valve body 28.

In a front face recess 42 of the piston 38 remote from the valve body 28, an upper valve disk 32 is inserted, with a covering disk 44 bearing against said upper valve disk 32, the covering disk 44 being secured by means of the locking nut 19.

A plurality of flow ducts are provided to connect the first working chamber part 14 with the second working chamber part 15. A fluid flow along the flow ducts occurs in particular in the blocking position of the overload valve 45 shown in FIG. 2.

In the blocking position, the fluid flows from the first working chamber part 14 along a radial gap 46 between the inner wall 34 of the housing 2 and an outer side of the covering disk 44 and/or through axial borings 47 in the covering disk 44. The fluid continues to flow along the axial borings 39 in the piston 38. In the blocking position, an axial fluid flow through the first through borings is impossible because the first through borings 31 are sealed by the valve disk 23 so in the region of the front faces of the piston 38 and the valve body 28 abutting against each other, the fluid continues to flow in a direction transverse to the longitudinal axis. The fluid then flows along the second through borings 32 and along the transverse ducts 36 into the axial duct 35, and from there into the second working chamber part 15. This throttled flow is possible both in the insertion direction 48 and in the pull-out direction, counter thereto, of the piston rod 7.

When the fluid damper 1 is exposed to an excess load, in particular when the piston rod 7 is rapidly inserted into the housing 2 along the insertion direction 48, the damping fluid displaced in the first through borings 31 of the valve body 28 acts on the valve disk 23 and in particular on the main protrusions 25. Owing to its elasticity, the valve disk 23 can be lifted off the first through borings 31 in the region of the main protrusions 25, causing the first through borings 31 to be opened in such a way that a bypass duct is provided.

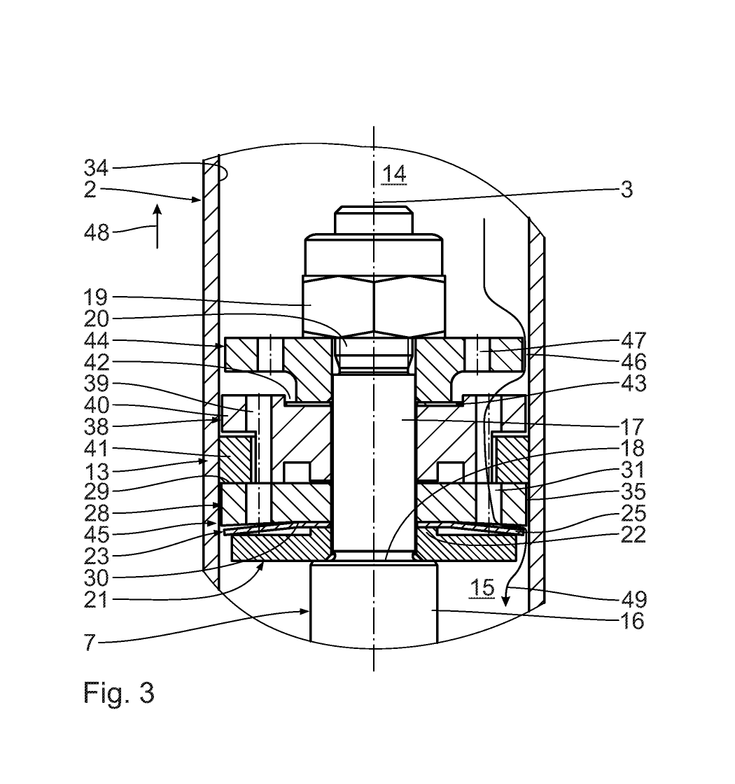

The valve plate 23 is lifted off the bypass ducts in response to a minimum fluid pressure, which is referred to as switching point. The switching point is adjustable by changing the material for the valve disk. The minimum fluid pressure can further be adjusted by changing the number and/or the size, in other words the diameter, of the first through borings 31. The fluid flow in the release position is shown by flow arrow 49 in FIG. 3.

The elastic deformation of the valve disk 23 is geometrically limited by the protective washer 21. The protective washer 21 serves as a support for the valve disk 23, in particular for the main protrusions 25.

The minimum fluid pressure can also be influenced by defining the radial distance, in other words the first radius r₁. The larger the first radius r₁, the smaller the minimum fluid pressure required to lift the valve disk 23 off the first through boring 31.

The valve disk 23 is elastically resilient, thus forming a spring member. When the fluid pressure decreases again, the valve disk 23 reverts automatically to its initial position, which is the blocking position, shown in FIG. 2.

The valve disk 23 abuts against the first through boring 31 in a sealing manner The valve disk 23 is a sealing member.

It is particularly advantageous that the overload valve 45 has a compact and in particular lightweight design, allowing it to be integrated in the available installation space of a piston rod of an already existing fluid damper. The design of the overload valve 45 is simple. The overload valve 45 comprises in particular the valve body 28 with the through borings 31 configured as bypass duct and the valve disk 23.

The piston unit 13 comprises the protective washer 21, the valve disk 23, the valve body 28, the piston 38, the piston ring 41, the upper valve disk 43 and the covering disk 44. The flow duct is formed by the individual ducts, which are in fluidic communication with each other, in particular the second through borings 32, the transverse ducts 36, the axial duct 35, the axial borings 39, the radial gap 46 and/or the axial borings 47.

The piston unit 13 is secured to the piston rod 7 in the region of the piston portion 17. A displacement of the piston rod 7 along the longitudinal axis 3 immediately results in a displacement of the piston unit 13.

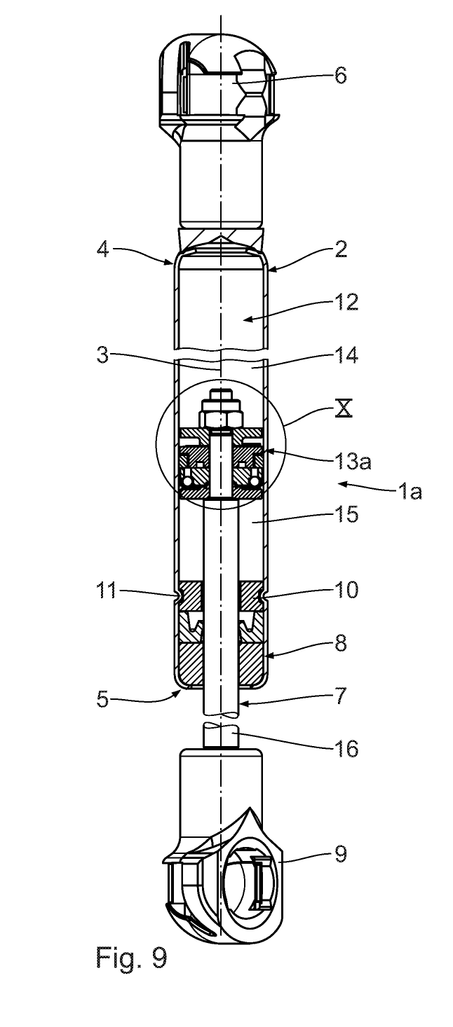

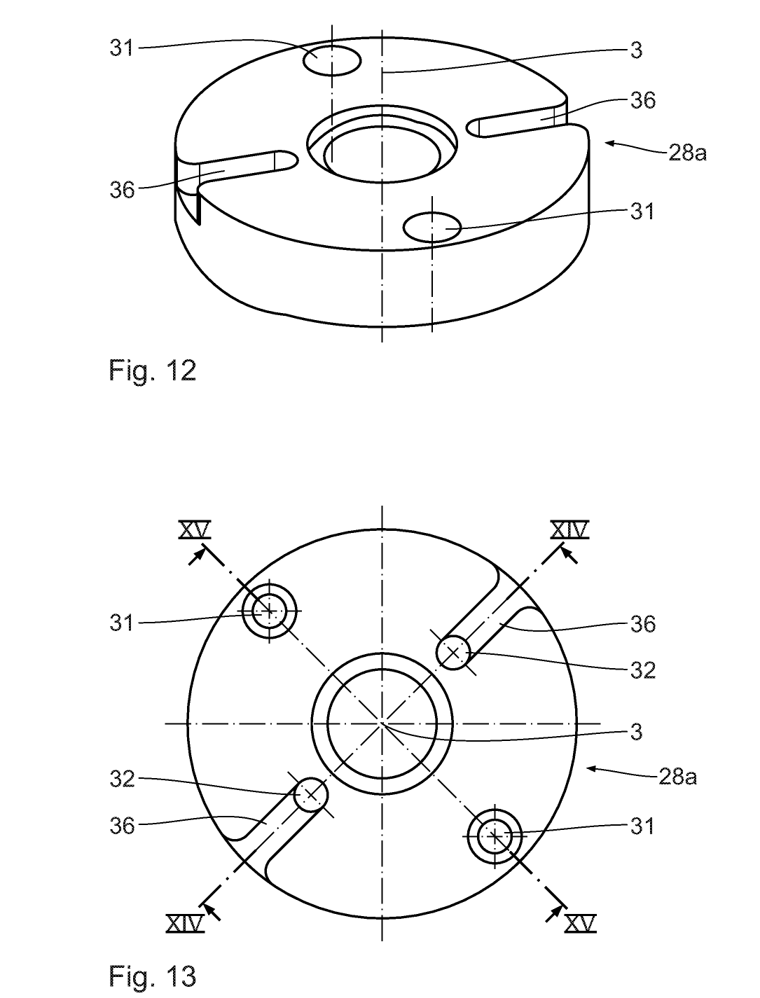

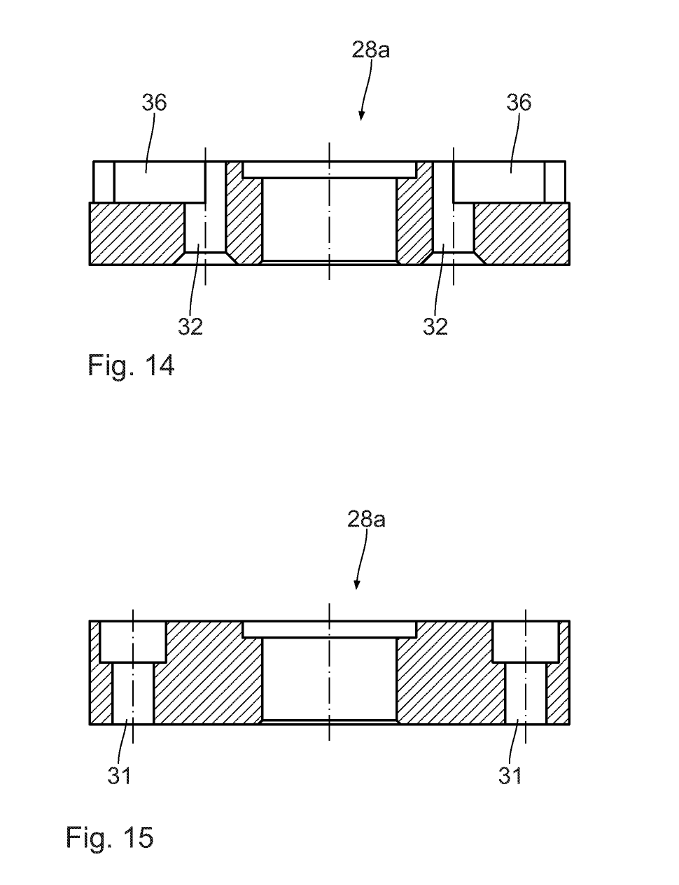

A second exemplary embodiment of the invention will hereinafter be described with reference to FIGS. 9 to 15. Identical parts are provided with the same reference numerals as in the first exemplary embodiments, to the description of which reference is hereby made. Structurally different but functionally identical parts are provided with the same reference numerals followed by the letter a.

Differences with respect to the preceding exemplary embodiment can be found in the design of the piston unit 13a and in particular of the overload valve 45a. The valve body 28a has two first through borings 31 and two second through borings 32, which are in each case arranged in pairs in such a way as to be arranged in a diametrically opposite configuration relative to the longitudinal axis 3. The encircling axial duct 35a of the second exemplary embodiment is essentially formed in that the external diameter of the valve body 26a is smaller than the internal diameter of the housing 2.

Another difference with respect to the first exemplary embodiment is that the valve disk 23a does not have a sealing function in the first place. The valve disk 23a is no sealing member. The valve disk 23a is a spring member provided to press a sealing ball 50, serving as a sealing member, against a seal seat 51 configured as a step along the first through boring 31. The sealing ball 51 is made of chromium steel.

The valve disk 23a is in particular configured as a circular ring disk.

According to the exemplary embodiment shown, the piston 38a has no axial borings. This is equally true for the covering disk 44a, which has no axial borings either.

In addition to the annular collar 22, the protective washer 21 is further provided with a receiving collar 52 arranged centrally, with the valve disk 23a being placed thereupon in such a way as to be held in the radial direction relative to the longitudinal axis 3. The valve disk 23a is secured axially be the annular collar 22. The protective washer 21a provides support to the bent valve disk 23a in the manner already described above.

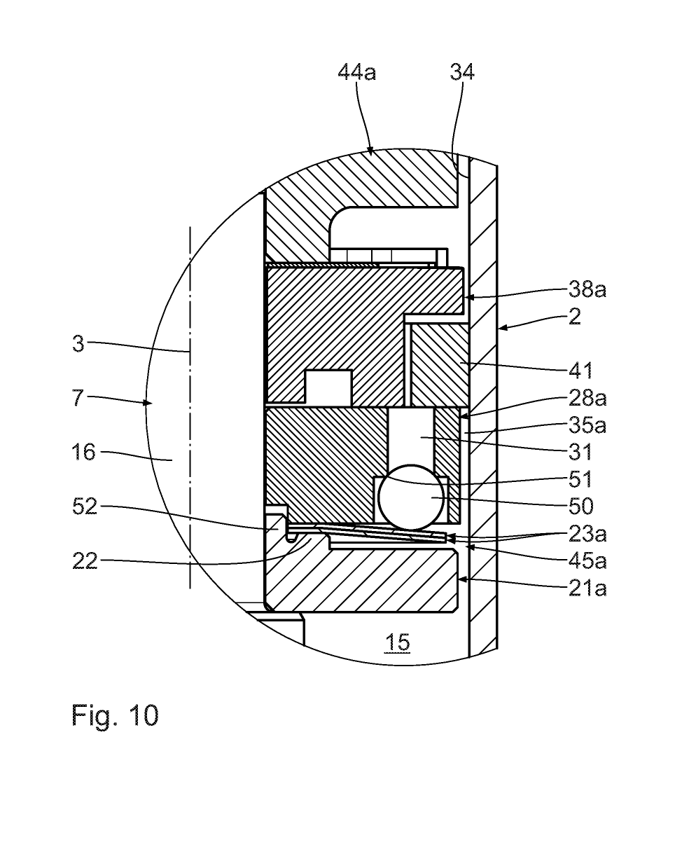

In the blocking position of the overload valve 45a shown in FIG. 10, the fluid flows essentially along the outer radial gaps between the covering disk 44a and the inner wall 34 and between the piston 38a and the inner wall 34 along the front-end contact face between the piston 38a and the valve body 28a along the second through borings 32 and the transverse ducts 36, through the axial duct 35, past the protective washer 21a and into the second working chamber part 15.

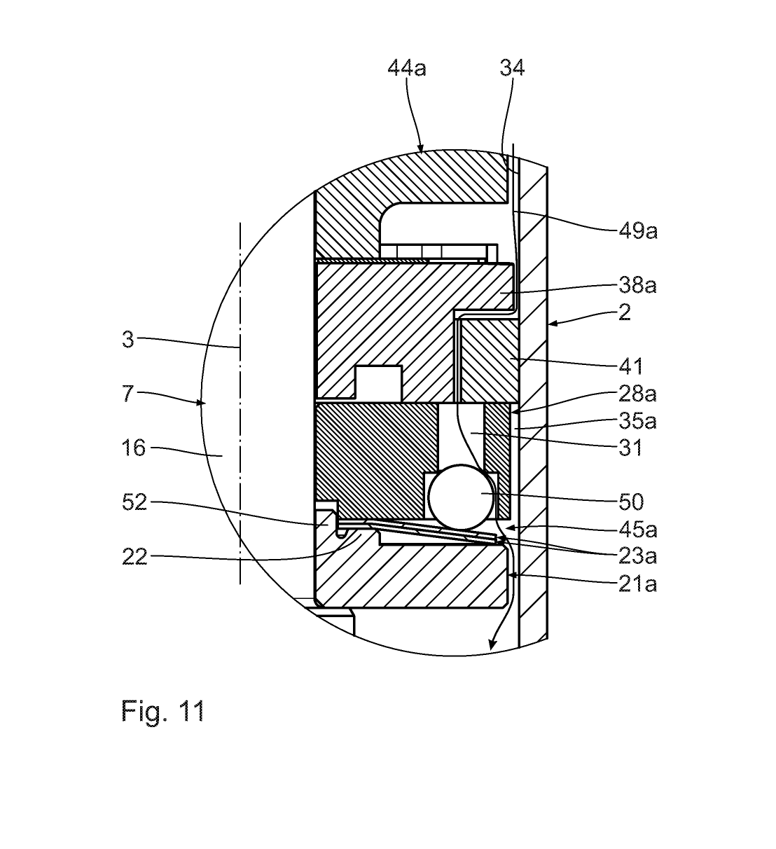

As soon as the minimum fluid pressure of the first through boring 31 is reached, the sealing ball 50 is lifted off the seal seat 51 counter to the resilient force exerted by the valve disk 23a in such a way that a fluid flow through the bypass duct provided by the through borings 31 is possible. The fluid flow is illustrated by the flow arrow 49a in FIG. 11.

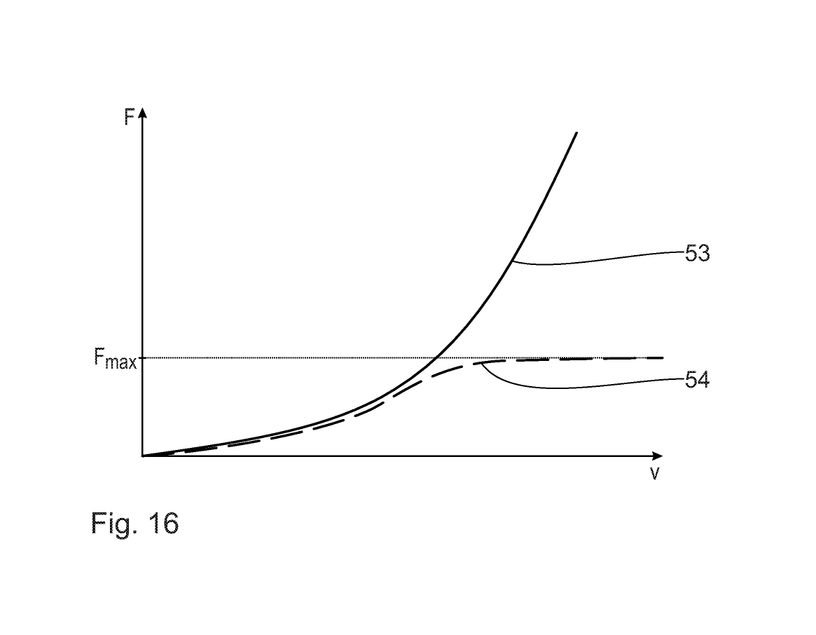

The damping effect of the fluid damper according to the invention will now be explained by means of a damper curve shown in FIG. 16. In this highly schematic diagram, a loading speed v of a fluid damper is represented by the ordinate thereof while the damping force F generated by the fluid damper is represented by the abscissa. The continuous line 53 represents the damper curve of a prior art fluid damper. The damper curve is highly progressive. The more rapidly the fluid damper is actuated, the higher the damping force.

The dashed line shows the damper curve 54 of a fluid damper according to the invention. At low loading speeds v, the curve 54 of the fluid damper according to the invention is substantially identical to the curve 53 of the prior art damper. At high speeds, the overload valve will open in accordance with the invention, with the result that a force in the damper is limited to the maximum force Fₘₐₓ. The maximum force Fₘₐₓ represents the switching point, which is adjustable as explained above.

What is claimed is:

1. A fluid damper (1; 1a) comprising
a. a housing (2) having a working chamber (12),
b. a damping fluid disposed in the working chamber (12),
c. a piston unit (13; 13a) arranged in the working chamber (12), the piston unit (13; 13a) comprising
i. a piston rod (7),
ii. a piston (38; 38a) secured to the piston rod (7), the piston (38; 38a) dividing the working chamber (12) in a first working chamber part (14) and a second working chamber part (15),
iii. at least one flow duct (32, 35, 36, 39, 46, 47) interconnecting the first working chamber part (14) and the second working chamber part (15),
iv. at least one bypass duct (31) interconnecting the first working chamber part (14) and the second working chamber part (15),
v. an overload valve (45) that blocks a fluid flow through the bypass duct (31) in a blocking position and is arranged in a release position as soon as a minimum fluid pressure is reached, wherein in said release position, a fluid flow through the bypass duct (31) is possible.

2. The fluid damper (1; 1a) according to claim 1, wherein the minimum fluid pressure is adjustable.

3. The fluid damper (1, 1a) according to claim 1, comprising at least one sealing member (23; 50) configured to seal the bypass duct (31) in the blocking position.

4. The fluid damper (1; 1a) according to claim 3, comprising a seal seat (51) against which the sealing member (23; 50) abuts in a sealing manner in the blocking position.

5. The fluid damper (1; 1a) according to claim 1, comprising a valve disk (23; 23a) serving as a spring member and in particular as a sealing member.

6. The fluid damper (1; 1a) according to claim 1, comprising a sealing ball (50) serving as a sealing member.

7. The fluid damper (1; 1a) according to claim 1, wherein the bypass duct (31) has a first flow cross-sectional area that is greater than a second flow cross-sectional area of the flow duct.

8. The fluid damper (1; 1a) according to claim 1, wherein the overload valve (45; 45a) has at least one of a compact design and a lightweight design.

9. The fluid damper (1; 1a) according to claim 8, wherein the overload valve (45; 45a) has a compact design in the axial direction of the fluid damper.

10. The fluid damper (1; 1a) according to claim 1, wherein the overload valve (45; 45a) has a valve body (28; 28a).

11. The fluid damper (1; 1a) according to claim 10, wherein the valve body (28; 28a) of the overload valve (45; 45a) is secured to the piston rod (7).

12. The fluid damper (1; 1a) according to claim 10, wherein the bypass duct (31) is integrated in the valve body (28; 28a).

13. The fluid damper (1; 1a) according to claim 1, wherein the overload valve (45; 45a) has a support ring (21).

14. The fluid damper (1; 1a) according to claim 13, wherein the support ring (21) of the overload valve (45; 45a) is secured to the piston rod (7).

15. The fluid damper (1; 1a) according to claim 14, wherein the valve disk (23; 23a) is arranged between the support ring (21) and the valve body (28; 28a).

16. The fluid damper (1; 1a) according to claim 1, wherein the piston unit (13; 13a) has a flow sealing member.

17. The fluid damper (1; 1a) according to claim 16, wherein the flow sealing member is configured as a piston ring (41).
